(19) United States
(12) Patent Application Publication
(10) Pub. No.: US 2026/0039849 A1
(43) Pub. Date: Feb. 5, 2026

(54) POINT CLOUD DECODING DEVICE, POINT CLOUD DECODING METHOD, AND PROGRAM

(71) Applicant: KDDI CORPORATION, Tokyo (JP)

(72) Inventors: Yohei HANAOKA, Fujimino-shi (JP); Satoshi KOMORITA, Fujimino-shi (JP); Kyohei UNNO, Fujimino-shi (JP); Kei KAWAMURA, Fujimino-shi (JP)

(73) Assignee: KDDI CORPORATION, Tokyo (JP)

(21) Appl. No.: 19/351,098

(22) Filed: Oct. 6, 2025

Related U.S. Application Data
(63) Continuation of application No. PCT/JP2024/008606, filed on Mar. 6, 2024.

(30) Foreign Application Priority Data
Apr. 14, 2023 (JP) 2023-066201

(51) Int. Cl. H04N 19/44; H04N 19/13; H04N 19/597; H04N 19/70

(52) U.S. Cl. CPC H04N 19/44; H04N 19/13; H04N 19/597; H04N 19/70

(57) ABSTRACT

The purpose of the present invention is to enable improvement in coding efficiency in an Angular mode and an adaptive azimuth angle quantization mode of Predictive geometry coding. A point cloud decoding device according to the present invention includes: a tree synthesizing unit configured to perform determination based on a threshold related to the number of azimuth angle steps and the decoded number of azimuth angle steps in an Angular mode and an adaptive azimuth angle quantization mode of Predictive geometry coding, and to determine a context to be used for decoding a radius residual based on a result of the determination.

### CROSS-REFERENCE TO RELATED APPLICATIONS

The present application is a continuation of PCT Application No. PCT/JP2024/008606, filed on Mar. 6, 2024, which claims the benefit of Japanese patent application No. 2023-066201 filed on Apr. 14, 2023; the entire contents of each application being incorporated herein by reference in its entirety.

### TECHNICAL FIELD

The present invention relates to a point cloud decoding device, a point cloud decoding method, and a program.

### BACKGROUND ART

Reference 2 (G-PCC 2nd Edition codec description, ISO/IEC JTC1/SC29/WG7 N00314) discloses a method of determining a context to be used for decoding a radius residual according to a decoded predictor index and the decoded number of azimuth angle steps in an Angular mode and an adaptive azimuth angle quantization mode of Predictive geometry coding.

### SUMMARY OF THE INVENTION

However, in the method of Reference 2, when determining the context to be used for decoding the radius residual, whether or not the decoded number of azimuth angle steps is 0 is used as one condition, but there is a problem in that the condition is not an optimal condition according to a data sequence to be decoded.

Therefore, the present invention has been made in view of the above-described problem, and an object of the present invention is to provide a point cloud decoding device, a point cloud decoding method, and a program that enable improvement in coding efficiency in an Angular mode and an adaptive azimuth angle quantization mode of Predictive geometry coding.

A first feature of the present invention is summarized as a point cloud decoding device including: a tree synthesizing unit configured to perform determination based on a threshold related to the number of azimuth angle steps and the decoded number of azimuth angle steps in an Angular mode and an adaptive azimuth angle quantization mode of Predictive geometry coding, and to determine a context to be used for decoding a radius residual based on a result of the determination.

A second feature of the present invention is summarized as a point cloud decoding device including a tree synthesizing unit configured to inversely quantize a decoded radius residual.

A third feature of the present invention is summarized as a point cloud decoding device including a tree synthesizing unit configured to select a predictor with a 0-th predictor index as a parent node or a correlation predictor.

A fourth feature of the present invention is summarized as a point cloud decoding device including a tree synthesizing unit configured to calculate an optimal predictor in advance in a decoded node and perform prediction by referring to the optimal predictor.

A fifth feature of the present invention is summarized as a point cloud decoding method including: a step of performing determination based on a threshold related to the number of azimuth angle steps and the decoded number of azimuth angle steps in an Angular mode and an adaptive azimuth angle quantization mode of Predictive geometry coding, and determining a context to be used for decoding a radius residual based on a result of the determination.

A sixth feature of the present invention is summarized as a program for causing a computer to function as a point cloud decoding device, wherein the point cloud decoding device includes a tree synthesizing unit configured to perform determination based on a threshold related to the number of azimuth angle steps and the decoded number of azimuth angle steps in an Angular mode and an adaptive azimuth angle quantization mode of Predictive geometry coding, and to determine a context to be used for decoding a radius residual based on a result of the determination.

According to the present invention, it is possible to provide a point cloud decoding device, a point cloud decoding method, and a program that enable improvement in coding efficiency in an Angular mode and an adaptive azimuth angle quantization mode of Predictive geometry coding.

### BRIEF DESCRIPTION OF THE DRAWINGS

FIG. 1 is a diagram illustrating an example of a configuration of a point cloud processing system 10 according to an embodiment.

FIG. 2 is a diagram illustrating an example of functional blocks of a point cloud decoding device 200 according to an embodiment.

FIG. 3 is a diagram illustrating an example of a configuration of encoded data (bit stream) received by a geometry information decoding unit 2010 of the point cloud decoding device 200 according to an embodiment.

FIG. 4 is a diagram illustrating an example of a syntax configuration of a geometry parameter set (GPS) 2011.

FIG. 5 is a flowchart illustrating an example of an operation of a tree synthesizing unit 2020 of the point cloud decoding device 200 according to an embodiment.

FIG. 6 is a flowchart illustrating an example of processing of decoding predictor information and a spherical coordinate residual in step S504.

FIG. 7 is a flowchart illustrating an example of processing of decoding the spherical coordinate residual in step S604.

FIG. 8 is a flowchart illustrating an example of processing of decoding a radius residual in step S702.

FIG. 9 is a flowchart illustrating an example of processing of predicting position information in step S505.

FIG. 10 is a flowchart illustrating an example of processing of generating a predictor by using a predictor list and calculating a predicted value in step S902.

FIG. 11 is a flowchart illustrating an example of prediction processing including a correlation predictor in step S1002.

FIG. 12 is a flowchart illustrating an example of processing of decoding the predictor information and the spherical coordinate residual in step S504.

FIG. 13 is a flowchart illustrating an example of prediction of the position information in step S505.

FIG. 14 is a flowchart illustrating an example of processing of generating a predictor according to an optimal predictor of a reference node and calculating a predicted value in step S1304.

FIG. 15 is a diagram illustrating an example of functional blocks of a point cloud encoding device 100 according to the present embodiment.

### DESCRIPTION OF EMBODIMENTS

An embodiment of the present invention will be described hereinbelow with reference to the drawings. Note that the constituent elements of the embodiment below can, where appropriate, be substituted with existing constituent elements and the like, and that a wide range of variations, including combinations with other existing constituent elements, is possible. Therefore, there are no limitations placed on the content of the invention as in the claims on the basis of the disclosures of the embodiment hereinbelow.

### First Embodiment

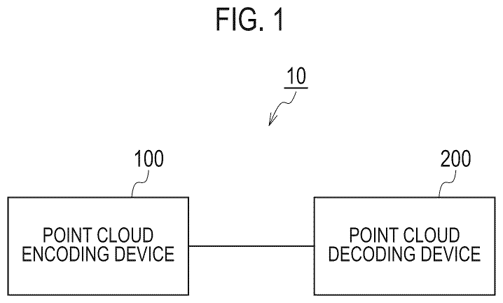

Hereinafter, a point cloud processing system 10 according to a first embodiment of the present invention will be described with reference to FIGS. 1 to 15. FIG. 1 is a diagram illustrating the point cloud processing system 10 according to an embodiment of the present embodiment.

As illustrated in FIG. 1, the point cloud processing system 10 includes a point cloud encoding device 100 and a point cloud decoding device 200.

The point cloud encoding device 100 is configured to generate encoded data (bit stream) by encoding an input point cloud signal. The point cloud decoding device 200 is configured to generate an output point cloud signal by decoding the bit stream.

Note that the input point cloud signal and the output point cloud signal include position information and attribute information of each point in a point cloud. The attribute information is, for example, color information or a reflection ratio of each point.

Here, such a bit stream may be transmitted from the point cloud encoding device 100 to the point cloud decoding device 200 through a transmission path. Furthermore, the bit stream may be stored in a storage medium, and then provided from the point cloud encoding device 100 to the point cloud decoding device 200.

### (Point Cloud Decoding Device 200)

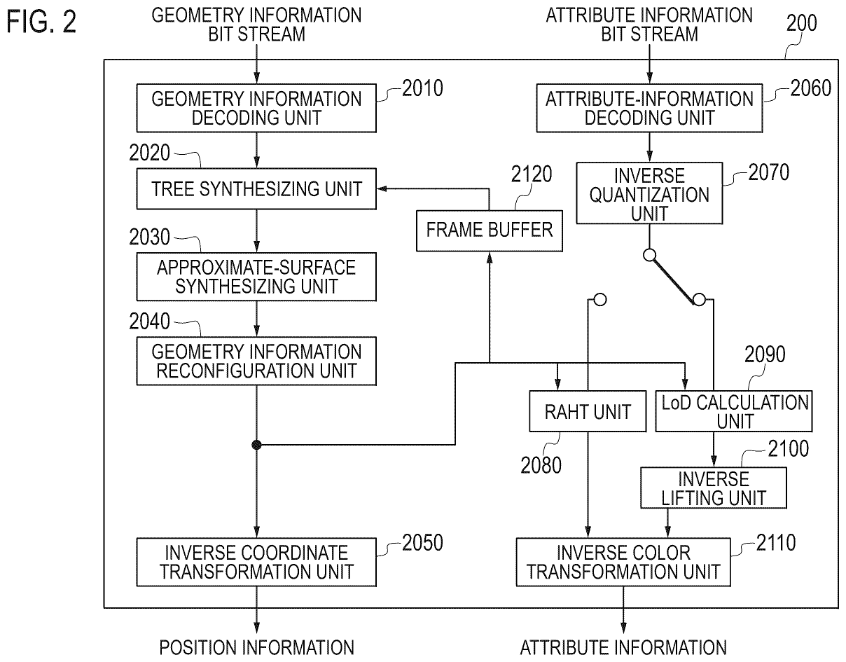

Hereinafter, the point cloud decoding device 200 according to the present embodiment will be described with reference to FIG. 2. FIG. 2 is a diagram illustrating an example of functional blocks of the point cloud decoding device 200 according to the present embodiment.

As illustrated in FIG. 2, the point cloud decoding device 200 includes a geometry information decoding unit 2010, a tree synthesizing unit 2020, an approximate-surface synthesizing unit 2030, a geometry information reconfiguration unit 2040, an inverse coordinate transformation unit 2050, an attribute-information decoding unit 2060, an inverse quantization unit 2070, a region adaptive hierarchical transform (RAHT) unit 2080, a level-of-detail (LoD) calculation unit 2090, an inverse lifting unit 2100, an inverse color transformation unit 2110, and a frame buffer 2120.

The geometry information decoding unit 2010 is configured to use, as input, a bit stream about geometry information (geometry information bit stream) among bit streams output from the point cloud encoding device 100, and to decode syntax.

Decoding processing is, for example, context-adaptive binary arithmetic decoding processing. Here, for example, the syntax includes control data (flags and parameters) for controlling the decoding processing of the position information.

The tree synthesizing unit 2020 is configured to use, as input, the control data, which has been decoded by the geometry information decoding unit 2010, and an occupancy code indicating on which node in a tree described later a point cloud is present, and to generate tree information indicating in which region in a decoding target space points are present.

Note that the tree synthesizing unit 2020 may be configured to perform decoding processing of an occupancy code.

The present process can generate the tree information by recursively repeating processing of partitioning the decoding target space into cuboids, determining whether or not a point is present in each cuboid by referring to the occupancy code, dividing the cuboid in which the point is present into a plurality of cuboids, and referencing the occupancy code.

Here, inter prediction described later may be used in decoding the occupancy code.

In the present embodiment, it is possible to use a method called “octree” in which octree division is recursively carried out with the above-described cuboids always as cubes, and a method called “QtBt” in which quadtree division and binary tree division are carried out in addition to octree division. Whether or not “QtBt” is to be used is transmitted as the control data from the point cloud encoding device 100 side.

Alternatively, the tree synthesizing unit 2020 is configured to, when the control data designates use of predictive geometry coding, decode the coordinates of each point based on an arbitrary tree configuration determined by the point cloud encoding device 100.

The approximate-surface synthesizing unit 2030 is configured to generate approximate-surface information using the tree information generated by the tree synthesizing unit 2020, and decode a point cloud based on this approximate-surface information.

For example, in a case where a point cloud is densely distributed on the surface of an object when decoding three-dimensional point cloud data of the object or the like, the approximate-surface information approximates and expresses a region in which the point cloud is present by a small plane instead of decoding each point cloud.

More specifically, the approximate-surface synthesizing unit 2030 can generate the approximate-surface information and decode the point cloud by, for example, a method called “Trisoup”. A specific “Trisoup” processing example will be described later. In addition, when decoding a sparse point cloud acquired by Lidar or the like, the present processing can be omitted.

The geometry information reconfiguration unit 2040 is configured to reconfigure the geometry information (position information on the coordinate system assumed by the decoding processing) of each point of decoding target point cloud data based on the tree information generated by the tree synthesizing unit 2020 and the approximate-surface information generated by the approximate-surface synthesizing unit 2030.

The inverse coordinate transformation unit 2050 is configured to use, as input, the geometry information reconfigured by the geometry information reconfiguration unit 2040, to transform the coordinate system assumed by the decoding processing into a coordinate system of the output point cloud signal, and to output the position information.

The frame buffer 2120 is configured to use, as input, the geometry information reconfigured by the geometry information reconfiguration unit 2040 to store as a reference frame. The stored reference frame is read from the frame buffer 2120 and used as a reference frame in a case where the tree synthesizing unit 2020 performs inter prediction on temporally different frames.

Here, which time reference frame is used for each frame may be determined based on, for example, control data transmitted as a bit stream from the point cloud encoding device 100.

The attribute-information decoding unit 2060 is configured to use, as input, a bit stream (attribute-information bit stream) about the attribute information among the bit streams output from the point cloud encoding device 100, and to decode syntax.

The decoding processing is, for example, context-adaptive binary arithmetic decoding processing. Here, for example, the syntax includes control data (flags and parameters) for controlling the decoding processing of the attribute information.

Furthermore, the attribute-information decoding unit 2060 is configured to decode quantized residual information from the decoded syntax.

The inverse quantization unit 2070 is configured to perform an inverse quantization process based on the quantized residual information decoded by the attribute-information decoding unit 2060 and quantization parameters that are one of items of the control data decoded by the attribute-information decoding unit 2060, and to generate inverse-quantized residual information.

The inverse-quantized residual information is output to one of the RAHT unit 2080 and the LOD calculation unit 2090 according to a feature of the decoding target point cloud. To which one of the RAHT unit 2080 and the LoD calculation unit 2090 the inverse-quantized residual information is output is designated by the control data decoded by the attribute-information decoding unit 2060.

The RAHT unit 2080 is configured to use, as input, the inverse-quantized residual information generated by the inverse quantization unit 2070, and the geometry information generated by the geometry information reconfiguration unit 2040, and to decode the attribute information of each point by using a type of Haar transformation (that is inverse Haar transformation in the decoding processing) called Region Adaptive Hierarchical Transform (RAHT). As specific processes of the RAHT, for example, the method described in Reference 1 (G-PCC codec description, ISO/IEC JTC1/SC29/WG7 N00271) can be used.

The LoD calculation unit 2090 is configured to use, as input, the geometry information generated by the geometry information reconfiguration unit 2040, and to generate a Level of Detail (LoD).

The LoD is information for defining a reference relationship (a point that refers to and a point to be referred to) for implementing predictive coding such as encoding or decoding of a prediction residual by predicting attribute information of a certain point from attribute information of another certain point.

In other words, the LoD is information defining a hierarchical structure in which each point included in the geometry information is classified into a plurality of levels, and for a point belonging to a lower level, an attribute is encoded or decoded using attribute information of a point belonging to an upper level.

As a specific LOD determination method, for example, the method described in Reference 1 described above may be used.

The inverse lifting unit 2100 is configured to decode the attribute information of each point based on a hierarchical structure defined by the LOD using the LOD generated by the LOD calculation unit 2090 and the inverse-quantized residual information generated by the inverse quantization unit 2070. As specific processes of inverse lifting, for example, the method described in Reference 1 described above can be used.

The inverse color transformation unit 2110 is configured to, when the attribute information of the decoding target is the color information, and color transformation has been carried out on the point cloud encoding device 100 side, perform an inverse color transformation process on the attribute information output from the RAHT unit 2080 or the inverse lifting unit 2100. Whether or not to perform the inverse color transformation process is determined according to the control data decoded by the attribute-information decoding unit 2060.

The point cloud decoding device 200 is configured to decode and output the attribute information of each point in the point cloud by the above processes.

### (Geometry Information Decoding Unit 2010)

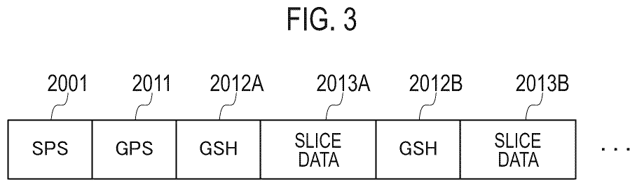

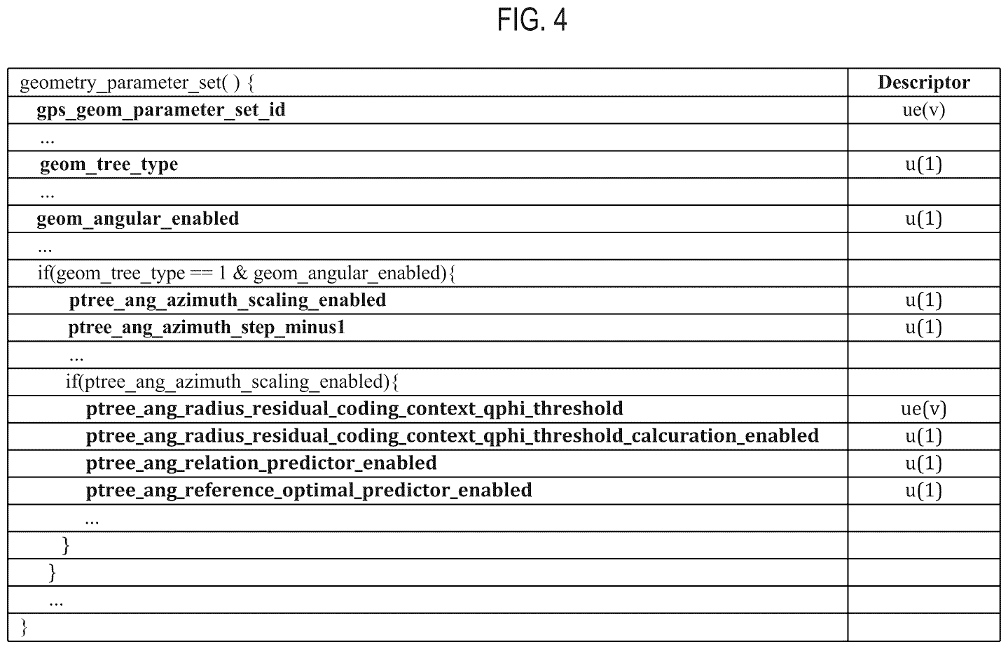

The control data decoded by the geometry information decoding unit 2010 will be described below with reference to FIGS. 3 and 4.

FIG. 3 illustrates an example of a configuration of encoded data (bit stream) received by the geometry information decoding unit 2010.

First, the bit stream may include a GPS 2011. The GPS 2011 is also called a geometry parameter set, and is a set of control data related to decoding of the geometry information. A specific example thereof will be described later. Each GPS 2011 includes at least GPS id information for identifying the individual GPSs 2011 in a case where there are the plurality of GPSs 2011.

Second, the bit stream may include a GSH 2012A/2012B. The GSH 2012A/2012B is also called a geometry slice header or a geometry data unit header, and is a set of control data corresponding to a slice to be described later. Hereinafter, a description will be given using the term “slice”, but the slice may be read as a data unit. A specific example thereof will be described later. The GSH 2012A/2012B includes at least GPS id information for designating the GPS 2011 associated with each of the GSH 2012A/2012B.

Third, the bit stream may include slice data 2013A/2013B in addition to the GSH 2012A/2012B. The slice data 2013A/2013B includes data obtained by encoding the geometry information. An example of the slice data 2013A/2013B includes the occupancy code to be described later.

As described above, the bit stream is configured such that each slice data 2013A/2013B is associated with the GSH 2012A/2012B and the GPS 2011 one by one.

As described above, since which GPS 2011 is referred to in the GSH 2012A/2012B is designated by the GPS id information, the GPS 2011 common to a plurality of items of slice data 2013A/2013B can be used.

In other words, the GPS 2011 does not necessarily need to be transmitted for each slice. For example, the bit stream may be configured such that the GPS 2011 is not encoded immediately before the GSH 2012B and the slice data 2013B as in FIG. 3.

Note that the configuration in FIG. 3 is merely an example. As long as each slice data 2013A/2013B is configured to be associated with the GSH 2012A/2012B and the GPS 2011, an element other than those described above may be added as a constituent element of the bit stream.

For example, as illustrated in FIG. 3, the bit stream may include a sequence parameter set (SPS) 2001. Similarly, the bit stream may have a configuration different from that in FIG. 3 at the time of transmission. Furthermore, the bit stream may be synthesized with a bit stream decoded by the attribute-information decoding unit 2060 described later and transmitted as a single bit stream.

FIG. 4 illustrates an example of a syntax configuration of the GPS 2011.

Note that syntax names described below are merely examples. The syntax names may vary as long as the functions of the syntaxes described below are similar.

The GPS 2011 may include GPS id information (gps_geom_parameter_set_id) for identifying each GPS 2011.

Note that a Descriptor column in FIG. 4 indicates how each syntax is encoded. ue(v) means an unsigned 0-order exponential-Golomb code, and u(1) means a 1-bit flag.

The GPS 2011 may include a flag (geom_tree_type) for controlling a tree type in the tree synthesizing unit 2020.

For example, when the value of geom_tree_type is “1”, it may be defined that Predictive geometry coding is used, and when the value of geom_tree_type is “0”, it may be defined that octree is used.

The GPS 2011 may include a flag (geom_angular_enabled) for controlling whether or not to perform processing in an Angular mode in the tree synthesizing unit 2020.

For example, when the value of geom_angular_enabled is “1”, it may be defined that Predictive geometry coding is performed in the Angular mode, and when the value of geom_angular_enabled is “0”, it may be defined that Predictive geometry coding is not performed in the Angular mode.

The GPS 2011 may include a flag (ptree_ang_azimuth_scaling_enabled) for controlling whether or not an adaptive azimuth angle quantization mode is activated in the Angular mode by the tree synthesizing unit 2020. The adaptive azimuth angle quantization mode is a mode for performing adaptive quantization of an azimuth angle according to a radius.

For example, when the value of ptree_ang_azimuth_scaling_enabled is “1”, it may be defined that the adaptive azimuth angle quantization according to the radius is performed, and when the value of ptree_ang_azimuth_scaling_enabled is “0”, it may be defined that the adaptive azimuth angle quantization according to the radius is not performed.

Furthermore, in calculation (selection) of a predictor in the Angular mode, the flag may be used as a flag for controlling whether or not to use the predictor list. In the present embodiment, the predictor is a concept including a linear predictor.

For example, when the value of ptree_azimuth_scaling_enabled is “1”, it may be defined that the predictor list is used in the calculation of such a predictor, and when the value of ptree_ang_azimuth_scaling_enabled is “0”, it may be defined that the predictor list is not used in the calculation of such a predictor.

The GPS 2011 may include a value (ptree_ang_azimuth_step_minus1) related to a rotation speed of a laser used to calculate a predicted value of an azimuth angle in the Angular mode by the tree synthesizing unit 2020.

The GPS 2011 may include a threshold (ptree_ang_radius_residual_coding_context_qphi_threshold) related to the number of azimuth angle steps used when decoding the radius residual in the Angular mode and the adaptive azimuth angle quantization mode by the tree synthesizing unit 2020.

The GPS 2011 may include a second threshold (ptree_ang_radius_residual_coding_context_qphi_threshold2) related to the number of azimuth angle steps used when decoding the radius residual in the Angular mode and the adaptive azimuth angle quantization mode by the tree synthesizing unit 2020.

The GPS 2011 may include a flag (ptree_ang_radius_residual_coding_context_qphi_threshold calculation enabled) for controlling whether or not to derive the threshold related to the number of azimuth angle steps in the Angular mode and the adaptive azimuth angle quantization mode using a decoder by the tree synthesizing unit 2020.

For example, when the value of ptree_ang_radius_residual_coding_context_qphi_threshold_calculation enabled is “1”, it may be defined that such a threshold is derived using the decoder, and when the value of ptree_ang_radius_residual_coding_context_qphi_threshold_calculation_enabled is “0”, it may be defined that such a threshold is not derived using the decoder.

The GPS 2011 may include a flag (ptree_ang_relation_predictor_enabled_flag) for controlling whether or not to use the correlation predictor using a correlation of a plurality of decoded nodes such as parent nodes in the Angular mode and the adaptive azimuth angle quantization mode by the tree synthesizing unit 2020.

For example, when the value of ptree_ang_predictor_enabled_flag is “1”, it may be defined that such a correlation predictor is used, and when the value of ptree_ang_predictor_enabled_flag is “0”, it may be defined that such a correlation predictor is not used.

The GPS 2011 may include a flag (ptree_ang_reference_optimal_predictor_enabled_flag) for controlling whether or not to generate the predictor using an optimal predictor of the reference node and perform prediction in the Angular mode and the adaptive azimuth angle quantization mode by the tree synthesizing unit 2020.

For example, when the value of ptree_ang_predictor_enabled_flag is “1”, it may be defined that the predictor is generated using the optimal predictor of the reference node, and when the value of ptree_ang_reference_optimal_predictor_enabled_flag is “0”, it may be defined that the predictor is not generated using the optimal predictor of the reference node.

### (Tree Synthesizing Unit 2020)

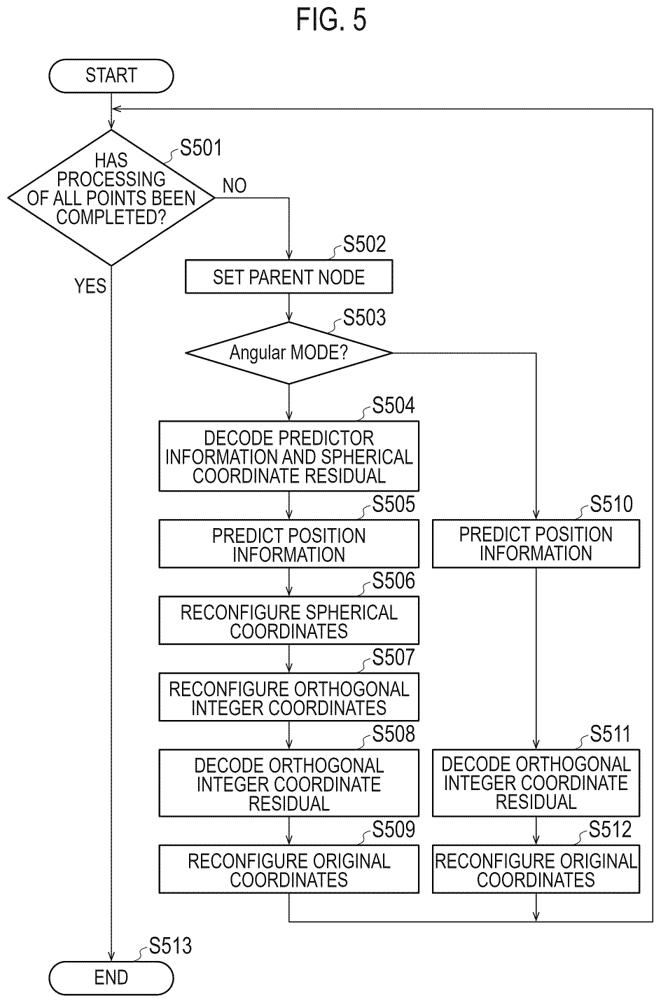

Hereinafter, an example of an operation of the tree synthesizing unit 2020 will be described with reference to FIGS. 5 to 13.

FIG. 5 is a flowchart illustrating an example of processing in the tree synthesizing unit 2020. Note that an example in a case where trees are synthesized using “Predictive geometry coding” will be described below.

The Predictive geometry coding is also called predictive tree. The Predictive geometry coding is a means for decoding a residual of position information predicted based on an arbitrary tree structure determined on a point cloud encoding device 100 side and position information of the point cloud data, and for decoding the position information of the point cloud data by adding both pieces of the position information.

As illustrated in FIG. 5, in step S501, the tree synthesizing unit 2020 determines whether or not decoding of the position information of all the pieces of point cloud data included in the slice has been completed.

In the present processing, for example, information indicating the number of pieces of point cloud data included in the slice is transmitted to the GSH, and the number of pieces of point cloud data is compared with the number of pieces of already processed data, so that it is possible to determine whether or not the processing of all the points has been completed.

In a case where the decoding of the position information of all the pieces of point cloud data has been completed, the present operation proceeds to step S513, and the processing is terminated. In a case where the decoding of the position information of all the pieces of point cloud data has not been completed, the present operation proceeds to step S502.

In step S502, the tree synthesizing unit 2020 sets a parent node of a decoding target node (processing target node) of the point cloud data.

For example, the tree synthesizing unit 2020 decodes the number of child nodes of each node, and stores node indexes corresponding to the number of child nodes in each node.

Then, in a case where the decoding target node is processed after a certain node, the tree synthesizing unit 2020 may refer to an array of the indexes of the node, acquire one index stored at the end of the array, and set a node of the acquired index as a parent node of the decoding target node.

After the setting of the parent node is completed, the present operation proceeds to step S503.

In step S503, the tree synthesizing unit 2020 determines whether or not to perform the processing in the Angular mode.

For example, the tree synthesizing unit 2020 can determine whether or not to perform the processing in the Angular mode by referring to the value of geom_angular_enabled described above.

In the case of performing the processing in the Angular mode, the present operation proceeds to step S504, and in the case of not performing the processing in the Angular mode, the present operation proceeds to step S510.

In step S504, the tree synthesizing unit 2020 decodes predictor information and a spherical coordinate residual. Here, the spherical coordinate residual indicates a residual of the radius, the azimuth angle, or a laser ID. When the decoding is completed, the present operation proceeds to step S505.

In step S505, the tree synthesizing unit 2020 predicts the position information based on the predictor information. Here, the predictor information is a predictor index or a prediction mode.

In such processing, the tree synthesizing unit 2020 first determines the type of the predictor to be used for prediction.

For example, the tree synthesizing unit 2020 may determine whether or not to perform the processing in the adaptive azimuth angle quantization mode based on the value of ptree_ang_azimuth_scaling_enabled, and determine the type of the predictor to be used based on the determination result.

For example, in the case of performing the prediction in the adaptive azimuth angle quantization mode, the tree synthesizing unit 2020 may select the type of the predictor to be used from among a plurality of predictors calculated using the tree structure based on a decoded predictor mode.

For example, in the case of the adaptive azimuth angle quantization mode, the tree synthesizing unit 2020 may select the predictor to be used based on the decoded prediction mode from among the plurality of predictors calculated using the tree structure.

Alternatively, in the case of performing the processing in the adaptive azimuth angle quantization mode, the tree synthesizing unit 2020 may hold the position information of the decoded node in the list as the predictor, refer to the predictor allocated to the decoded predictor index from the list, and select the predictor as the type of the predictor to be used.

Once the type of the predictor is determined, the tree synthesizing unit 2020 sets the predictor as the predicted value of the position information. A specific processing example will be described later.

After the prediction of the position information is completed, the present operation proceeds to step S506.

In step S506, the tree synthesizing unit 2020 reconfigures spherical coordinates. In such processing, the tree synthesizing unit 2020 reconfigures the spherical coordinates by adding the decoded spherical coordinate residual and the predictor.

After the reconfiguration is completed, the present operation proceeds to step S507.

In step S507, the tree synthesizing unit 2020 reconfigures orthogonal integer coordinates. In such processing, the tree synthesizing unit 2020 can convert the spherical coordinates into the orthogonal integer coordinates based on the reconfigured spherical coordinates. As a specific method, for example, the method described in Reference 1 can be implemented.

After the reconfiguration of the orthogonal integer coordinates is completed, the present operation proceeds to step S508.

In step S508, the tree synthesizing unit 2020 decodes an orthogonal integer coordinate residual.

After the decoding of the orthogonal integer coordinate residual is completed, the present operation proceeds to step S509.

In step S509, the tree synthesizing unit 2020 reconfigures the original coordinates. In such processing, the tree synthesizing unit 2020 reconfigures the original coordinates by adding the decoded orthogonal integer coordinate residual and the reconfigured orthogonal integer coordinates.

After the reconfiguration of the original coordinates is completed, the present operation returns to step S501.

In step S510, the tree synthesizing unit 2020 predicts the position information. Specifically, the tree synthesizing unit 2020 selects the predictor, and sets the predictor as the predicted value of the position information.

For example, the tree synthesizing unit 2020 may select, based on the decoded predictor mode, the predictor from among the plurality of predictors calculated based on the tree structure.

After the prediction of the position information is completed, the present operation proceeds to step S511.

In step S511, the tree synthesizing unit 2020 decodes the orthogonal integer coordinate residual.

After the decoding of the orthogonal integer coordinate residual is completed, the present operation proceeds to step S512.

In step S512, the tree synthesizing unit 2020 reconfigures the original coordinates. In such processing, the tree synthesizing unit 2020 reconfigures the original coordinates by adding the orthogonal integer coordinate residual decoded in step S511 and the position information predicted in step S510.

After the reconfiguration of the original coordinates is completed, the present operation returns to step S501.

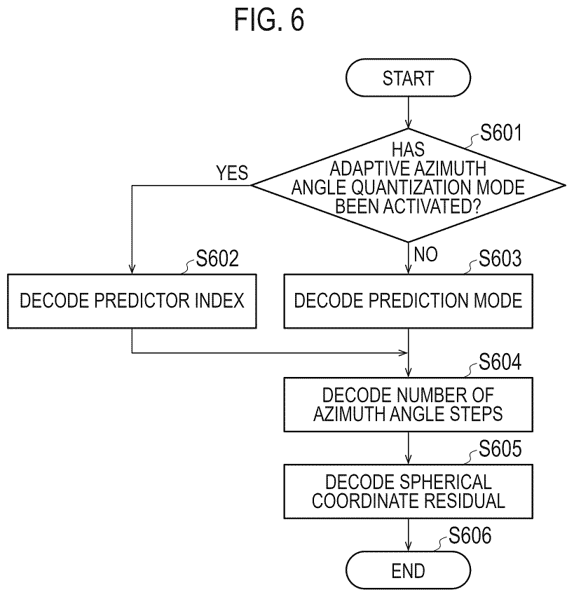

FIG. 6 is a flowchart illustrating an example of processing of decoding the predictor information and the spherical coordinate residual in step S504.

As illustrated in FIG. 6, in step S601, the tree synthesizing unit 2020 determines whether or not the adaptive azimuth angle quantization mode has been activated based on the value of ptree_ang_azimuth_scaling_enabled.

In a case where the adaptive azimuth angle quantization mode has been activated, the present operation proceeds to step S602. On the other hand, in a case where the adaptive azimuth angle quantization mode has not been activated, the present operation proceeds to step S603.

In step S602, the tree synthesizing unit 2020 decodes the predictor index. After the decoding of the predictor index is completed, the present operation proceeds to step S604.

In step S603, the tree synthesizing unit 2020 decodes the prediction mode. After the decoding of the prediction mode is completed, the present operation proceeds to step S604.

In step S604, the tree synthesizing unit 2020 decodes the number of azimuth angle steps. After the decoding of the number of azimuth angle steps is completed, the present operation proceeds to step S605.

In step S605, the tree synthesizing unit 2020 decodes the spherical coordinate residual. After the decoding is completed, the present operation proceeds to step S606, and the processing is terminated.

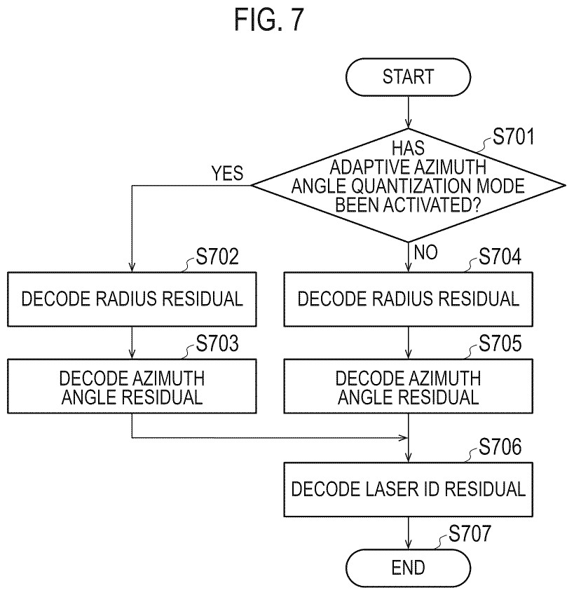

FIG. 7 is a flowchart illustrating an example of processing of decoding the spherical coordinate residual in step S604.

As illustrated in FIG. 7, in step S701, the tree synthesizing unit 2020 determines whether or not the adaptive azimuth angle quantization mode has been activated based on the value of ptree_ang_azimuth_scaling_enabled.

In a case where the adaptive azimuth angle quantization mode has been activated, the present operation proceeds to step S702. On the other hand, in a case where the adaptive azimuth angle quantization mode has not been activated, the present operation proceeds to step S704.

In step S702, the tree synthesizing unit 2020 decodes the radius residual. After the decoding of the radius residual is completed, the present operation proceeds to step S703.

In step S703, the tree synthesizing unit 2020 decodes the azimuth angle residual. After the decoding of the azimuth angle residual is completed, the present operation proceeds to step S706.

In step S704, the tree synthesizing unit 2020 decodes the radius residual. After the decoding of the radius residual is completed, the present operation proceeds to step S705.

In step S705, the tree synthesizing unit 2020 decodes the azimuth angle residual. After the decoding of the azimuth angle residual is completed, the present operation proceeds to step S706.

In step S706, the tree synthesizing unit 2020 decodes the laser ID residual. After the decoding of the laser ID residual is completed, the present operation proceeds to step S707, and the processing is terminated.

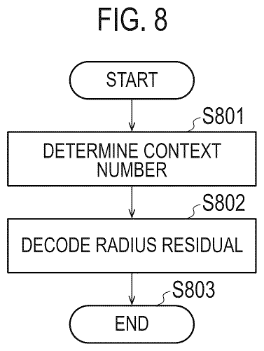

FIG. 8 is a flowchart illustrating an example of processing of decoding the radius residual in step S702.

As illustrated in FIG. 8, in step S801, the tree synthesizing unit 2020 determines the context.

For example, by using the decoded predictor index and the decoded number of azimuth angle steps, the tree synthesizing unit 2020 may select one context index that satisfies the condition from among four context indexes ctxIdx by using one threshold related to the number of azimuth angle steps as follows, and determine the context based on the context index.

$$if predIdx \neq 0 and \vert qphi \vert \leq x \qquad [ Math . 1 ]$$

$$if predIdx \neq 0 and \vert qphi \vert > x$$

$$if predIdx \neq 0 and \vert qphi \vert \leq x$$

$$if predIdx \neq 0 and \vert qphi \vert > x$$

Here, predIdx represents the predictor index, qphi represents the number of azimuth angle steps, and x represents the threshold related to the number of azimuth angle steps.

The tree synthesizing unit 2020 may use a specific hard-coded value as the threshold x. For example, the tree synthesizing unit 2020 may hard-code and use a specific value such as 0 as the threshold x.

Alternatively, the tree synthesizing unit 2020 may use the value of ptree_ang_radius_residual_coding_context_qphi_threshold as the threshold x.

Alternatively, the tree synthesizing unit 2020 refers to the value of ptree_ang_radius_residual_coding_context_qphi_threshold_calculation_enabled, and in a case where the tree synthesizing unit 2020 determines that the threshold x is derived using the decoder, the tree synthesizing unit 2020 may derive the threshold x by using syntax held by the GPS 2011.

For example, the tree synthesizing unit 2020 may derive the threshold x based on the value of ptree_ang_azimuth_step_minus1, which is a value related to the rotation speed of the laser used to calculate the predicted value of the azimuth angle.

For example, the tree synthesizing unit 2020 may calculate the threshold x as follows.

$$x = round ( \frac{A}{ptree\_ang \_azimuth \_step \_minus1} ) \qquad [ Math . 2 ]$$

Here, A is a constant, and may be, for example, a power of 2. In addition, round (*) is a function that returns an integer value by rounding an argument.

For example, the tree synthesizing unit 2020 may select the context index under the following conditions by using two thresholds related to the number of azimuth angle steps.

$$ctxIdx = \{ \begin{matrix}0 , & if & predIdx \neq 0 and x \leq \vert qphi \vert < y \\ 1 , & if & predIdx \neq 0 and ( \vert qphi \vert < x or \vert qphi \vert \geq y ) \\ 2 , & if & predIdx = 0 and x \leq \vert qphi \vert < y \\ 3 , & if & predIdx = 0 and ( \vert qphi \vert < x or \vert qphi \vert \geq y )\end{matrix} \qquad [ Math . 3 ]$$

Here, y represents the second threshold related to the number of azimuth angle steps.

For example, the tree synthesizing unit 2020 may use a specific value such as 0 as the threshold y.

Alternatively, the tree synthesizing unit 2020 may use the value of ptree_ang_radius_residual_coding_context_qphi_threshold2 as the threshold y.

For example, the tree synthesizing unit 2020 refers to the value of ptree_ang_radius_residual_coding_context_qphi_threshold_calculation_enabled, and in a case where the tree synthesizing unit 2020 determines that the threshold y is derived using the decoder, the tree synthesizing unit 2020 may derive the threshold y by using syntax held by the GPS 2011.

As described above, the tree synthesizing unit 2020 may perform determination using the threshold related to the number of azimuth angle steps and the number of decoded azimuth angle steps, and determine the context used to decode the radius residual based on the determination result. With such a configuration, a code amount of the radius residual can be reduced.

Once the context is determined, the present operation proceeds to step S802.

In step S802, the tree synthesizing unit 2020 decodes the radius residual.

In the present processing, the tree synthesizing unit 2020 performs context-adaptive binary arithmetic decoding processing based on the context determined in step S801.

Furthermore, In the present processing, the tree synthesizing unit 2020 may inversely quantize the decoded radius residual.

Here, the tree synthesizing unit 2020 may inversely quantize all the decoding target nodes with a uniform value or may inversely quantize all the decoding target nodes with a non-uniform value.

For example, the tree synthesizing unit 2020 may inversely quantize all the decoding target nodes with a non-uniform value according to a magnitude of the decoded radius residual.

Furthermore, for example, the tree synthesizing unit 2020 may inversely quantize all the decoding target nodes with a value linearly changed according to the magnitude of the radius residual, or may inversely quantize all the decoding target nodes with an exponential function.

As described above, the tree synthesizing unit 2020 may be configured to inversely quantize the radius residual. With such a configuration, a code amount of the radius residual can be reduced.

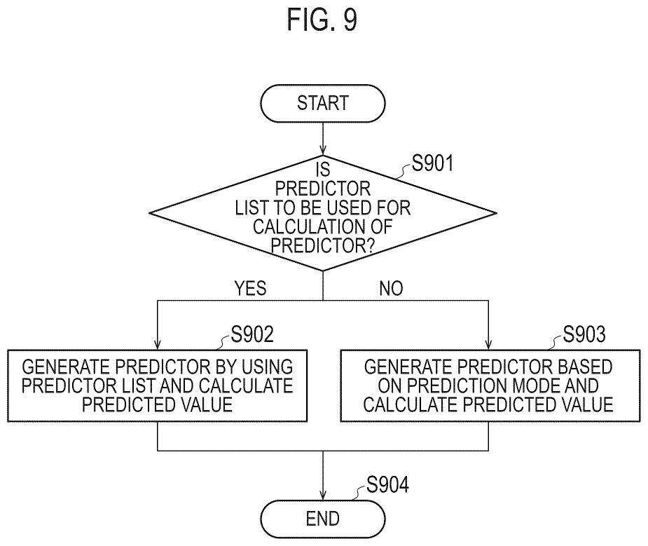

FIG. 9 is a flowchart illustrating an example of processing of predicting the position information in step S505.

As illustrated in FIG. 9, in step S901, the tree synthesizing unit 2020 determines whether or not to use the predictor list for the calculation of the predictor.

For example, the tree synthesizing unit 2020 may determine whether or not the adaptive azimuth angle quantization mode has been activated based on the value of ptree_ang_azimuth_scaling_enabled, and determine the type of the predictor to be used to calculate the predictor.

In the case of using the predictor list, the present operation proceeds to step S902, and in the case of not using the predictor list, the present operation proceeds to step S903.

In step S902, the tree synthesizing unit 2020 calculates the predictor by using the predictor list and predicts the position information.

In the present processing, the tree synthesizing unit 2020 may acquire position information corresponding to the decoded predictor index from the list from among pieces of position information of the decoded nodes held as the predictor list.

Alternatively, the tree synthesizing unit 2020 may use the position information of the parent node as the predictor based on the decoded predictor index.

Once the predictor is determined, the tree synthesizing unit 2020 calculates the predicted value of the position information by using the predictor. A specific processing example of the calculation of the predicted value will be described later.

After the prediction of the position information is completed, the present operation proceeds to step S904, and the processing is terminated.

In step S903, the tree synthesizing unit 2020 selects the predictor to be used from among the plurality of predictors calculated using the tree structure based on the decoded predictor mode, and sets the predictor as the predicted value of the position information.

For example, the tree synthesizing unit 2020 may select a mode to be used based on the decoded predictor mode from among a non-prediction mode, a prediction mode based on only a parent node, a prediction mode based on a parent node and a parent node thereof, and a prediction mode based on a parent node of a parent node and a parent node thereof.

Specifically, for example, the tree synthesizing unit 2020 can be implemented by the method described in Reference 1.

After the prediction of the position information is completed, the present operation proceeds to step S904, and the processing is terminated.

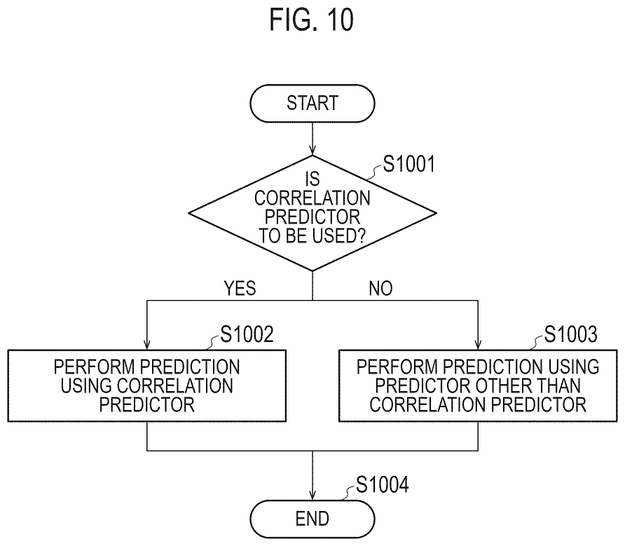

FIG. 10 is a flowchart illustrating an example of processing of generating the predictor by using the predictor list and calculating the predicted value in step S902.

As illustrated in FIG. 10, in step S1001, the tree synthesizing unit 2020 determines whether or not to use the correlation predictor. The correlation predictor is a predictor that is generated using the correlation of the decoded node such as the parent node.

For example, the tree synthesizing unit 2020 can determine whether or not to use the correlation predictor by referring to ptree_ang_relation_predictor_enabled_flag.

In the case of using the correlation predictor, the present operation proceeds to step S1002, and in the case of not using the correlation predictor, the present operation proceeds to step S1003.

In step S1002, the tree synthesizing unit 2020 performs prediction by using the correlation predictor.

In the present processing, the tree synthesizing unit 2020 generates the correlation predictor or a predictor other than the correlation predictor based on the decoded predictor index, and predicts the position information of the decoding target node. Details will be described later.

Once such prediction is completed, the present operation proceeds to step S1004, and the processing is terminated.

In step S1003, the tree synthesizing unit 2020 performs prediction by using a predictor other than the correlation predictor.

In the present processing, the tree synthesizing unit 2020 generates a predictor other than the correlation predictor based on the decoded predictor index and predicts the position information of the decoding target node.

Once such prediction is completed, the present operation proceeds to step S1004, and the processing is terminated.

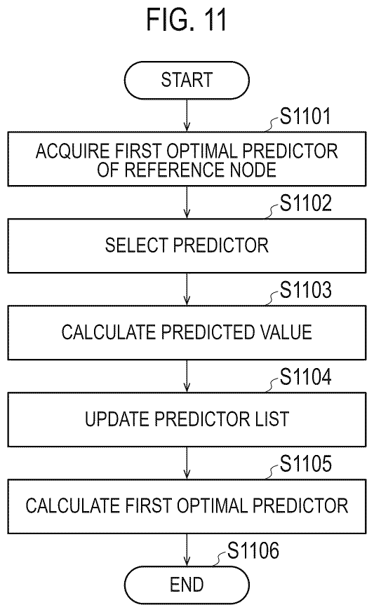

FIG. 11 is a flowchart illustrating an example of prediction processing including the correlation predictor in step S1002.

As illustrated in FIG. 11, in step S1101, the tree synthesizing unit 2020 acquires a first optimal predictor of the reference node.

Here, the reference node is a node that has already been decoded and is used to determine the predictor to be used by the decoding target node. In step S1105 described later, the tree synthesizing unit 2020 decodes the position information in the reference node, and then calculates the radius residual in each of a case where the parent node is the predictor and a case where the correlation predictor is the predictor.

As described later, the first optimal predictor is a predictor used when the predictor index of the decoding target node is 0, and is a predictor when the radius residual becomes smaller among the calculated radius residuals.

That is, after decoding the position information in the reference node, the tree synthesizing unit 2020 calculates which of the parent node and the correlation predictor results in a smaller radius residual when used as the predictor, and sets the predictor that results in a smaller radius residual as the first optimal predictor.

Here, when the predictor index of the decoding target node selected in step S1102 is 0, the tree synthesizing unit 2020 uses the first optimal predictor of the reference node to determine the parent node or the correlation predictor as the predictor.

For example, in a case where the first optimal predictor of the reference node is the parent node, the predictor index 0 of the decoding target node indicates the parent node, and when the first optimal predictor of the reference node is the correlation predictor, the predictor index 0 of the decoding target node indicates the correlation predictor.

For example, the tree synthesizing unit 2020 may use, as the reference node, a node having the smallest azimuth angle among nodes having an azimuth angle equal to or larger than an azimuth angle of a node decoded immediately before the decoding target node from among laser IDs processed immediately before the laser ID of the decoding target node.

Furthermore, in a case where there is no laser ID processed immediately before the laser ID of the decoding target node, the tree synthesizing unit 2020 may use, as the reference node, the node decoded immediately before the decoding target node.

In a case where the decoding target node is a head node of each laser, the tree synthesizing unit 2020 may use, as the reference node, the node decoded immediately before the decoding target node.

After the selection of the reference node is completed, the tree synthesizing unit 2020 acquires the first optimal predictor of the reference node.

After the acquisition of the first optimal predictor of the reference node is completed, the present operation proceeds to step S1102.

In step S1102, the tree synthesizing unit 2020 selects the predictor. Here, when the decoded predictor index is 0, the tree synthesizing unit 2020 selects the predictor according to the acquired first optimal predictor of the reference node.

For example, the tree synthesizing unit 2020 sets the parent node as the predictor in a case where the first optimal predictor of the reference node is the parent node, and sets the correlation predictor as the predictor in a case where the first optimal predictor of the reference node is the correlation predictor.

For example, the correlation predictor may be a linear predictor generated based on a correlation between a parent node and a parent node of the parent node.

The tree synthesizing unit 2020 may calculate, for a linear predictor P_(pred_linear)=(r_(pred_linear), φ(pred_linear)), P_(pred_linear)=P_0+(P_0−P_1) by using position information P_0=(r_0,φ_0) of the parent node and position information P_1=(r_0,φ_1) of the parent node of the parent node.

Here, r represents the radius, and φ represents the azimuth angle.

Alternatively, the tree synthesizing unit 2020 may calculate r_(pred_linear)=r_0+(r_0−r_1) for only a radius r_(pred linear) of the linear predictor P_(pred_linear)=(r_(pred_linear), φ(pred_linear)) and may calculate φ_(pred linear)=φ_0 for an azimuth angle φ_(pred_linear).

When the decoded predictor index is other than 0, the tree synthesizing unit 2020 acquires position information corresponding to the decoded predictor index from the list from among the pieces of position information of the decoded nodes held as the predictor list.

After the selection of the predictor is completed, the present operation proceeds to step 1103.

In step S1103, the tree synthesizing unit 2020 calculates the predicted value. Specifically, the tree synthesizing unit 2020 acquires the predictor corresponding to the decoded predictor index from the predictor list, and calculates the predicted value based on the acquired predictor.

The predictor includes the azimuth angle and the radius of the already decoded node, and the tree synthesizing unit 2020 can calculate the predictor by, for example, the method described in Reference 2 based on information obtained by adding the decoded laser ID of the parent node to the azimuth angle and the radius.

After the calculation of the predicted value is completed, the present operation proceeds to step S1104.

In step S1104, the tree synthesizing unit 2020 updates the predictor list. In such a predictor list, the decoded radius and azimuth angle are stored as the predictors.

Specifically, the tree synthesizing unit 2020 updates the predictor list by storing the radius and the azimuth angle that are decoded this time with the 0-th index in the predictor list.

Alternatively, in a case where the decoded prediction mode is the linear predictor, the tree synthesizing unit 2020 may store the linear predictor used for prediction with the 0-th index.

For example, update after the first index can be implemented by the method described in Reference 2.

After the update of the predictor list is completed, the present operation proceeds to step S1105.

In step S1105, the tree synthesizing unit 2020 calculates the first optimal predictor.

Here, the calculated first optimal predictor is referred to when the decoding target node is selected as the reference node in decoding nodes following the decoding target node.

In the present processing, the tree synthesizing unit 2020 calculates the radius residual in each of a case where the parent node is the predictor and a case where the correlation predictor is the predictor in the decoding target node, calculates which predictor originally results in a smaller radius residual when selected, and sets, as the first optimal predictor, the predictor that results in a smaller radius residual.

Specifically, the tree synthesizing unit 2020 compares a difference between the radius decoded in the decoding target node and the radius of the parent node with a difference between the radius decoded in the decoding target node and the radius of the correlation predictor, and sets the parent node as the first optimal predictor in a case where the difference from the parent node is smaller, and sets the correlation predictor as the first optimal predictor when the difference from the correlation predictor is smaller.

After the calculation of the first optimal predictor is completed, the present operation proceeds to step S1106, and the processing is terminated.

As described above, the tree synthesizing unit 2020 may be configured to select the parent node or the correlation predictor as the predictor with the 0-th predictor index. With such a configuration, the 0-th predictor index can be assigned to a more optimal predictor, and encoding efficiency can be improved.

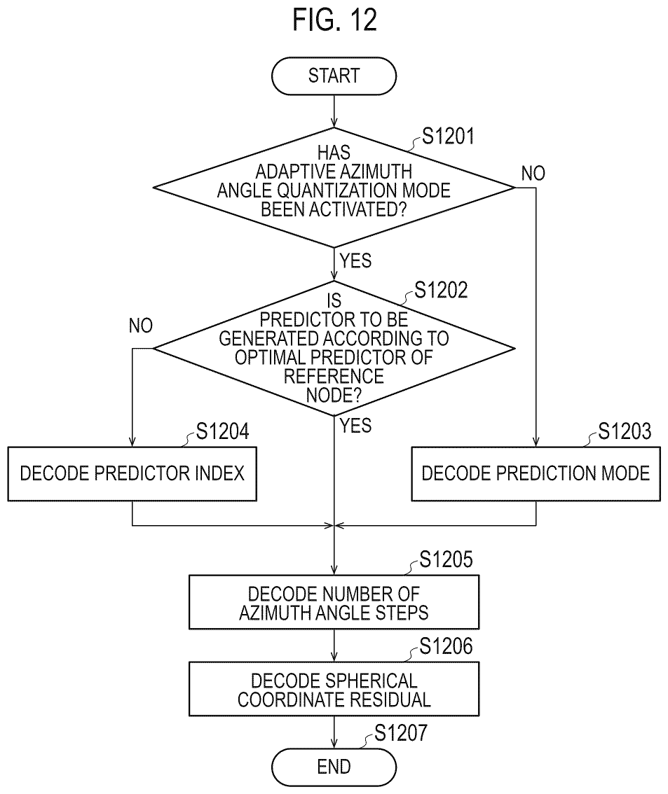

FIG. 12 is a flowchart illustrating an example of processing of decoding the predictor information and the spherical coordinate residual in step S504.

As illustrated in FIG. 12, in step S1201, the tree synthesizing unit 2020 determines whether or not the adaptive azimuth angle quantization mode has been activated based on the value of ptree_ang_azimuth_scaling_enabled.

In a case where the adaptive azimuth angle quantization mode has been activated, the present operation proceeds to step S1202. On the other hand, in a case where the adaptive azimuth angle quantization mode has not been activated, the present operation proceeds to step S1203.

In step S1202, the tree synthesizing unit 2020 determines whether or not to generate the predictor by using the optimal predictor of the reference node and perform prediction.

For example, based on the value of ptree_ang_reference_optimal_predictor_enabled_flag, the tree synthesizing unit 2020 may determine whether or not to generate the predictor by using the optimal predictor of the reference node and perform prediction.

In the case of generating the predictor by using the optimal predictor of the reference node, the present operation proceeds to step S1205, and in the case of not generating the predictor by using the optimal predictor of the reference node, the present operation proceeds to step S1204.

In step S1203, the tree synthesizing unit 2020 decodes the prediction mode. After the decoding of the prediction mode is completed, the present operation proceeds to step S604.

In step S1204, the tree synthesizing unit 2020 decodes the predictor index. After the predictor index decoding is completed, the present operation proceeds to step S1205.

In step S1205, the tree synthesizing unit 2020 decodes the number of azimuth angle steps. After the decoding of the number of azimuth angle steps is completed, the present operation proceeds to step S1206.

In step S1206, the tree synthesizing unit 2020 decodes the spherical coordinate residual.

Note that, in a case where the tree synthesizing unit 2020 determines not to generate the predictor by using the optimal predictor of the reference node based on the value of ptree_ang_reference_optimal_predictor_enabled_flag, in the decoding of the radius residual, the context is selected only on the condition of the number of azimuth angle steps.

After the decoding is completed, the present operation proceeds to step S1207, and the processing is terminated.

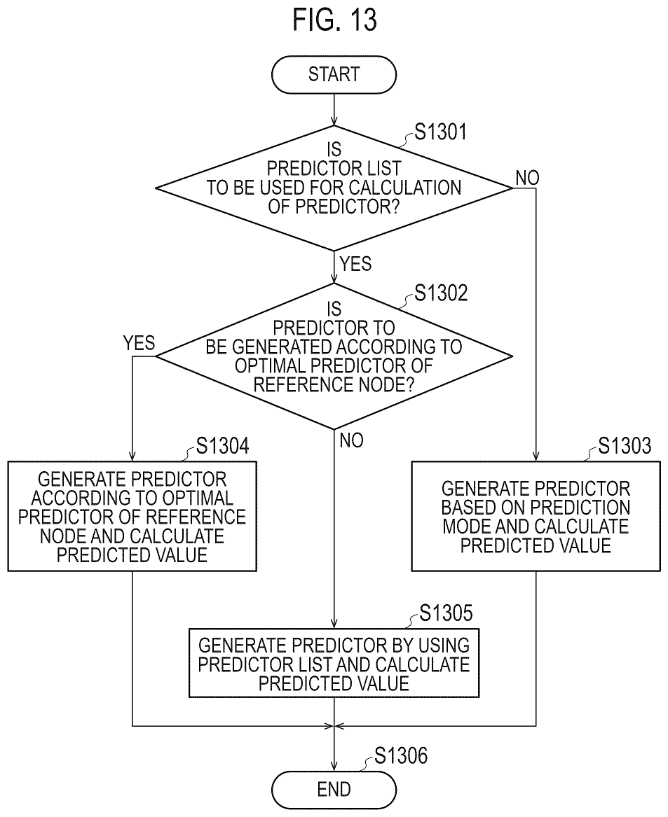

FIG. 13 is a flowchart illustrating an example of prediction of the position information in step S505.

As illustrated in FIG. 13, in step S1301, the tree synthesizing unit 2020 determines whether or not to use the predictor list for the calculation of the predictor.

For example, the tree synthesizing unit 2020 may determine whether or not the adaptive azimuth angle quantization mode has been activated based on the value of ptree_ang_azimuth_scaling_enabled, and determine the type of the predictor to be used to calculate the predictor.

In the case of using the predictor list, the present operation proceeds to step S1202, and in the case of not using the predictor list, the present operation proceeds to step S1303.

In step S1302, the tree synthesizing unit 2020 determines whether or not to generate the predictor by using the optimal predictor of the reference node and perform prediction.

For example, based on the value of ptree_ang_reference_optimal_predictor_enabled_flag, the tree synthesizing unit 2020 may determine whether or not to generate the predictor by using the optimal predictor of the reference node and perform prediction.

In the case of generating the predictor by using the optimal predictor of the reference node, the present operation proceeds to step S1304, and in the case of not generating the predictor by using the optimal predictor of the reference node, the present operation proceeds to step S1305.

In step S1303, the tree synthesizing unit 2020 selects the predictor to be used from among the plurality of predictors calculated using the tree structure based on the decoded predictor mode, and sets the predictor as the predicted value of the position information.

For example, the tree synthesizing unit 2020 may select a mode to be used based on the decoded predictor mode from among a non-prediction mode, a prediction mode based on only a parent node, a prediction mode based on a parent node and a parent node thereof, and a prediction mode based on a parent node of a parent node and a parent node thereof. Specifically, for example, such selection can be implemented by the method described in Reference 1.

After the prediction of the position information is completed, the present operation proceeds to step S1306, and the processing is terminated.

In step S1304, the tree synthesizing unit 2020 generates the predictor according to the optimal predictor of the reference node and calculates the predicted value.

Here, the reference node is a node that has already been decoded and is used to determine the predictor to be used by the decoding target node.

In addition, the optimal predictor is a predictor that results in the smallest radius residual when selected as a result of calculation among the predictors present in the predictor list after decoding the position information in the reference node.

In the present processing, the tree synthesizing unit 2020 acquires the optimal predictor of the reference node and calculates the predicted value based on the optimal predictor. Details will be described later.

After the calculation of the predicted value is completed, the present operation proceeds to step S1306, and the processing is terminated.

In step S1305, the tree synthesizing unit 2020 calculates the predictor by using the predictor list and predicts the position information.

In the present processing, the tree synthesizing unit 2020 may acquire position information corresponding to the decoded predictor index from the list from among pieces of position information of the decoded nodes held as the predictor list.

Alternatively, the tree synthesizing unit 2020 may use the position information of the parent node as the predictor based on the decoded predictor index.

Once the predictor is determined, the tree synthesizing unit 2020 calculates the predicted value of the position information by using such a predictor.

Once the prediction is completed, the present operation proceeds to step S1306, and the processing is terminated.

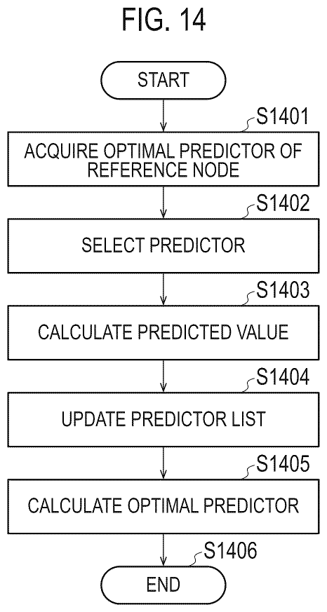

FIG. 14 is a flowchart illustrating an example of processing of generating the predictor according to the optimal predictor of the reference node and calculating the predicted value in step S1304.

As illustrated in FIG. 14, in step S1401, the tree synthesizing unit 2020 acquires the optimal predictor of the reference node.

For example, the tree synthesizing unit 2020 may use, as the reference node, a node having the smallest azimuth angle among nodes having an azimuth angle equal to or larger than an azimuth angle of a node decoded immediately before the decoding target node from among laser IDs processed immediately before the laser ID of the decoding target node.

Furthermore, in a case where there is no laser ID processed immediately before the laser ID of the decoding target node, the tree synthesizing unit 2020 may use, as the reference node, the node decoded immediately before the decoding target node.

In a case where the decoding target node is a head node of each laser, the tree synthesizing unit 2020 may use, as the reference node, the node decoded immediately before the decoding target node.

After the selection of the reference node is completed, the tree synthesizing unit 2020 acquires the optimal predictor of the reference node.

After the acquisition of the optimal predictor of the reference node is completed, the present operation proceeds to step S1402.

In step S1402, the tree synthesizing unit 2020 selects the predictor.

In the present processing, the tree synthesizing unit 2020 selects the predictor according to the acquired optimal predictor of the reference node.

For example, the tree synthesizing unit 2020 may directly use, as the predictor, the optimal predictor of the reference node, or may use, as the predictor, a node of the same laser as the decoding target node having the same azimuth angle as the optimal predictor of the reference node.

After the selection of the predictor is completed, the present operation proceeds to step 1403.

In step S1403, the tree synthesizing unit 2020 calculates the predicted value. The acquired predictor includes information regarding the radius and the azimuth angle of the decoded node.

In the present processing, the tree synthesizing unit 2020 can calculate the predictor by the method described in Reference 2, for example, based on information obtained by adding the acquired predictor and the decoded laser ID of the parent node.

After the calculation of the predicted value is completed, the present operation proceeds to step S1404.

In step S1404, the tree synthesizing unit 2020 updates the predictor list. In the predictor list, the decoded radius and azimuth angle are stored as the predictors.

When updating the predictor list, the tree synthesizing unit 2020 may store, for example, the predictor used for decoding at the end of the predictor list.

In addition, the tree synthesizing unit 2020 may make the predictor list independent for each laser ID.

For example, the tree synthesizing unit 2020 may create a new predictor list in a case where the decoded laser ID has changed from the previous laser ID.

In a case where the predictor list is made independent for each laser ID, when selecting the predictor in step S1402, the tree synthesizing unit 2020 selects the predictor by referring to the predictor list corresponding to the laser ID of the reference node.

After the update of the predictor list is completed, the present operation proceeds to step S1405.

In step S1405, the tree synthesizing unit 2020 calculates the optimal predictor.

The calculated optimal predictor is referred to when the decoding target node is selected as the reference node in decoding nodes following the decoding target node.

In the present processing, after decoding the position information in the reference node, the tree synthesizing unit 2020 calculates which node results in the smallest radius residual when used as the predictor among the already decoded nodes, and sets, as the optimal predictor, the predictor that results in the smallest radius residual.

After the calculation of the optimal predictor is completed, the present operation proceeds to step S1406, and the processing is terminated.

As described above, the tree synthesizing unit 2020 may be configured to calculate the optimal predictor in the decoded node in advance and to perform prediction by referring to the predictor.

With such a configuration, it is not necessary to decode the predictor index, and encoding efficiency can be improved.

### (Point Cloud Encoding Device 100)

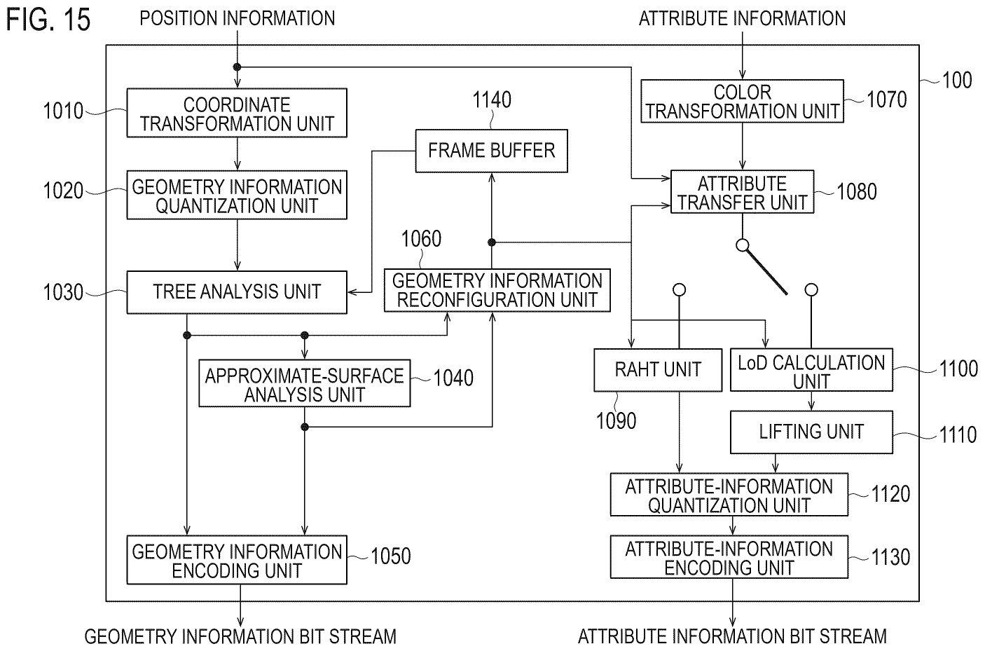

Hereinafter, the point cloud encoding device 100 according to the present embodiment will be described with reference to FIG. 15. FIG. 15 is a diagram illustrating an example of functional blocks of the point cloud encoding device 100 according to the present embodiment.

As illustrated in FIG. 15, the point cloud encoding device 100 includes a coordinate transformation unit 1010, a geometry information quantization unit 1020, a tree analysis unit 1030, an approximate-surface analysis unit 1040, a geometry information encoding unit 1050, a geometry information reconfiguration unit 1060, a color transformation unit 1070, an attribute transfer unit 1080, an RAHT unit 1090, an LoD calculation unit 1100, a lifting unit 1110, an attribute-information quantization unit 1120, an attribute-information encoding unit 1130, and a frame buffer 1140.

The coordinate transformation unit 1010 is configured to perform transformation processing from a three-dimensional coordinate system of an input point cloud to an arbitrary different coordinate system. In the coordinate transformation, for example, x, y, and z coordinates of the input point cloud may be transformed into arbitrary s, t, and u coordinates by rotating the input point cloud. Furthermore, as one of variations of the transformation, the coordinate system of the input point cloud may be used as it is.

The geometry information quantization unit 1020 is configured to perform quantization of position information of the input point cloud after the coordinate transformation and removal of points having overlapping coordinates. Note that, in a case where a quantization step size is 1, the position information of the input point cloud matches position information after quantization. That is, a case where the quantization step size is 1 is equivalent to a case where quantization is not performed.

The tree analysis unit 1030 is configured to generate an occupancy code indicating which node in an encoding target space a point is present, based on a tree structure to be described later, by using the position information of the point cloud after quantization as an input.

In the present processing, the tree analysis unit 1030 is configured to recursively partition the encoding target space into cuboids to generate the tree structure.

Here, in a case where a point is present in a certain cuboid, the tree structure can be generated by recursively performing processing of dividing the cuboid into a plurality of cuboids until the cuboid has a predetermined size. Each of such cuboids is referred to as a node. In addition, each cuboid generated by dividing the node is referred to as a child node, and the occupancy code is a code expressed by 0 or 1 as to whether or not a point is included in the child node.

As described above, the tree analysis unit 1030 is configured to generate the occupancy code while recursively dividing the node to a predetermined size.

In the present embodiment, it is possible to use a method called “octree” in which octree division is recursively carried out with the above-described cuboids always as cubes, and a method called “QtBt” in which quadtree division and binary tree division are carried out in addition to octree division.

Here, whether or not to use “QtBt” is transmitted to the point cloud decoding device 200 as control data.

Alternatively, it may be designated that Predictive geometry coding that uses any tree configuration is to be used. In such a case, the tree analysis unit 1030 determines the tree structure, and the determined tree structure is transmitted to the point cloud decoding device 200 as control data.

For example, the control data of the tree structure may be configured to be decoded by the procedure described in FIGS. 7 and 8.

The approximate-surface analysis unit 1040 is configured to generate approximate-surface information by using the tree information generated by the tree analysis unit 1030.

For example, in a case where a point cloud is densely distributed on the surface of an object when decoding three-dimensional point cloud data of the object or the like, the approximate-surface information approximates and expresses a region in which the point cloud is present by a small plane instead of decoding each point cloud.

Specifically, the approximate-surface analysis unit 1040 may be configured to generate the approximate-surface information by, for example, a method called “Trisoup”. In addition, when decoding a sparse point cloud acquired by Lidar or the like, the present processing can be omitted.

The geometry information encoding unit 1050 is configured to encode syntax such as the occupancy code generated by the tree analysis unit 1030 and the approximate-surface information generated by the approximate-surface analysis unit 1040 to generate a bit stream (geometry information bit stream). Here, the bit stream may include, for example, the syntax described with reference to FIG. 4.

The encoding processing is, for example, context-adaptive binary arithmetic encoding processing. Here, for example, the syntax includes control data (flags and parameters) for controlling the decoding processing of the position information.

The geometry information reconfiguration unit 1060 is configured to reconfigure geometry information (a coordinate system assumed by the encoding processing, that is, the position information after the coordinate transformation in the coordinate transformation unit 1010) of each point of the point cloud data to be encoded based on the tree information generated by the tree analysis unit 1030 and the approximate-surface information generated by the approximate-surface analysis unit 1040.

The frame buffer 1140 is configured to use, as input, the geometry information reconfigured by the geometry information reconfiguration unit 1060 and store the geometry information as a reference frame.

The stored reference frame is read from the frame buffer 1140 and used as a reference frame in a case where the tree analysis unit 1030 performs inter prediction of temporally different frames.

Here, which time reference frame is used for each frame may be determined based on, for example, a value of a cost function representing encoding efficiency, and information of the reference frame to be used may be transmitted to the point cloud decoding device 200 as the control data.

The color transformation unit 1070 is configured to perform color transformation when attribute information of the input is color information. The color transformation is not necessarily performed, and whether or not to perform the color transformation processing is encoded as a part of the control data and transmitted to the point cloud decoding device 200.

The attribute transfer unit 1080 is configured to correct an attribute value so as to minimize distortion of the attribute information based on the position information of the input point cloud, the position information of the point cloud after the reconfiguration in the geometry information reconfiguration unit 1060, and the attribute information after the color change in the color transformation unit 1070. As a specific correction method, for example, the method described in Reference 1 can be applied.

The RAHT unit 1090 is configured to use, as input, the attribute information after the transfer by the attribute transfer unit 1080 and the geometry information generated by the geometry information reconfiguration unit 1060, and to generate residual information of each point by using a type of Haar transform called region adaptive hierarchical transform (RAHT). As specific processes of the RAHT, for example, the method described in Reference 1 can be used.

The LoD calculation unit 1100 is configured to generate a level of detail (LoD) using the geometry information generated by the geometry information reconfiguration unit 1060 as an input.

The LoD is information for defining a reference relationship (a point that refers to and a point to be referred to) for implementing predictive coding such as encoding or decoding of a prediction residual by predicting attribute information of a certain point from attribute information of another certain point.

In other words, the LOD is information defining a hierarchical structure in which each point included in the geometry information is classified into a plurality of levels, and for a point belonging to a lower level, an attribute is encoded or decoded using attribute information of a point belonging to an upper level.

As a specific LOD determination method, for example, the method described in Reference 1 described above may be used.

The lifting unit 1110 is configured to generate the residual information by lifting processing using the LOD generated by the LOD calculation unit 1100 and the attribute information after the attribute transfer in the attribute transfer unit 1080.

As specific processes of the lifting, for example, the method described in Reference 1 described above may be used.

The attribute-information quantization unit 1120 is configured to quantize the residual information output from the RAHT unit 1090 or the lifting unit 1110. Here, a case where the quantization step size is 1 is equivalent to a case where quantization is not performed.

The attribute-information encoding unit 1130 is configured to perform encoding processing using the quantized residual information or the like output from the attribute-information quantization unit 1120 as syntax to generate a bit stream (attribute information bit stream) regarding the attribute information.

The encoding processing is, for example, context-adaptive binary arithmetic encoding processing. Here, for example, the syntax includes control data (flags and parameters) for controlling the decoding processing of the attribute information.

The point cloud encoding device 100 is configured to perform the encoding processing using the position information and the attribute information of each point in a point cloud as inputs and output the geometry information bit stream and the attribute information bit stream by the above processing.

The point cloud encoding device 100 and the point cloud decoding device 200 described above may be implemented as programs that cause a computer to execute each function (each step).

In the above embodiments, the present invention has been described using the application to the point cloud encoding device 100 and the point cloud decoding device 200 as an example. However, the present invention is not limited to such examples and can similarly be applied to a point cloud encoding/decoding system that incorporates the respective functions of the point cloud encoding device 100 and the point cloud decoding device 200.

According to the present embodiment, for example, comprehensive improvement in service quality can be realized in moving image communication, and thus, it is possible to contribute to the goal 9 “Build resilient infrastructure, promote inclusive and sustainable industrialization and foster innovation” of the sustainable development goal (SDGs) established by the United Nations.

What is claimed is:

1. A point cloud decoding device comprising a circuit, wherein
the circuit performs determination based on a threshold related to the number of azimuth angle steps and the decoded number of azimuth angle steps in an Angular mode and an adaptive azimuth angle quantization mode of Predictive geometry coding, and determines a context to be used for decoding a radius residual based on a result of the determination.

2. The point cloud decoding device according to claim 1, wherein
the circuit sets, as the threshold, a value of a threshold related to the number of azimuth angle steps used when decoding the radius residual.

3. The point cloud decoding device according to claim 2, wherein
the circuit decodes the threshold from a bit stream.

4. A point cloud decoding method comprising:
performing determination based on a threshold related to the number of azimuth angle steps and the decoded number of azimuth angle steps in an Angular mode and an adaptive azimuth angle quantization mode of Predictive geometry coding, and determining a context to be used for decoding a radius residual based on a result of the determination.

5. A program stored on a non-transitory computer-readable medium for causing a computer to function as a point cloud decoding device, wherein
the point cloud decoding device includes a circuit performs determination based on a threshold related to the number of azimuth angle steps and the decoded number of azimuth angle steps in an Angular mode and an adaptive azimuth angle quantization mode of Predictive geometry coding, and determines a context to be used for decoding a radius residual based on a result of the determination.
